(19) United States
(12) Patent Application Publication
(10) Pub. No.: US 2010/0085312 A1
(43) Pub. Date: Apr. 8, 2010

(54) Method and Apparatus for Dual Input Text Entry

(75) Inventor: Kevin Scott Kirkup, Raleigh, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/245,205

(22) Filed: Oct. 3, 2008

(51) Int. Cl. G06F 3/041

(52) U.S. Cl. 345/173

(57) ABSTRACT

A method and apparatus is provided for entering alphanumeric characters into a computing device. A user selects a row in a character array containing a plurality of alphanumeric characters using a first input device and selects a character in the row using a second user input device. A processor outputs the selected character to a display or to memory. The selected row may, in some embodiments, be displayed to the user on a display screen.

### BACKGROUND

The present invention relates generally to portable communication devices and, more particularly, to keyboard arrangements for portable communication devices.

In recent years, mobile phones have evolved from devices used primarily for voice communications into devices capable of both voice and data communications. Mobile phones can now be used to surf the web, send and receive text messages, send and receive emails, compose documents, and implement many other data communication functions that people once performed on computers. Many of these data communication functions require the user to enter-text. Many mobile communication devices still rely on a standard numeric phone keypad for text entry where a plurality of letters or symbols are assigned to each key. Text entry with a standard numeric keypad can be slow and laborious. Some mobile phones, such as the Blackberry, include a full QWERTY keypad to make text entry easier. Including a fully QWERTY keypad on a mobile phone makes text entry easier but consumes a large amount of space. Since space is limited in a mobile phone, it is desirable to provide a mechanism for text entry that is easier to use and more convenient than a standard numeric keypad, and takes less space than a conventional QWERTY keypad.

### SUMMARY

The present invention provides a method and apparatus for entering alphanumeric characters into a mobile phone or other portable computing device. The computing device may include a display for displaying text and other characters entered by a user. A first user input device is provided for selecting a row in a character array, and a second user input device is provided for selecting a character in the selected row. A processor receives input via the first and second user input devices and outputs the selected characters. The character array may, for example, comprise an array of characters that corresponds to a QWERTY keypad. The present invention takes up less space than a standard QWERTY keypad, while providing an easy and convenient method for text entry.

Exemplary embodiments of the invention comprise a device for entering alphanumeric characters into a computing device. One exemplary device comprises a first user input device for receiving user selection of a row in a character array containing a plurality of alphanumeric characters; a second user input device for receiving user selection of an alphanumeric character in a row of said character array selected by a user via the first user input device; and a processor to output the selected character responsive to user input received via the second user input device.

Some embodiments of the device may further comprise a display, and the processor may be configured to display the selected row on said display responsive to user input received via the first user input device.

In some embodiments of the device, the processor may be configured to change the appearance of the selected character on said display responsive to user input received via the second input device to indicate the user selection of a character.

In some embodiments of the device, the processor may be configured to highlight the selected character to indicate the user selection of a character to indicate a user selection of a character.

In some embodiments of the device, the processor is configured to change the size of the selected character to indicate the user selection of a character.

In some embodiments of the device, the display comprises a touch screen display that also functions as the second user input device for receiving user selection of a character in a selected row.

In some embodiments of the device, the first and second user input devices comprise one of an input key, a wheel, a pointing device, a touch-sensitive input, and an optical input.

Other embodiments of the invention comprise methods for inputting text into a computing device. One exemplary method comprises receiving a first user input at a first user input device indicating a user selection of a row in a character array containing a plurality of alphanumeric characters; receiving a second user input at a second user input device indicating user selection of an alphanumeric character in a row of said character array selected by a user via the first user input device; and outputting the selected character responsive to second user input.

Some exemplary methods may further comprise displaying the selected row of said character array on a display responsive to said first user input.

Some exemplary methods may further comprise changing an appearance of the selected character on said display responsive to said second user input to indicate the user selection of a character.

In some exemplary methods, changing an appearance of the selected character on said display comprises highlighting the selected character.

In some exemplary methods, changing an appearance of the selected character on said display comprises changing the size of the selected character.

In some exemplary methods, the display comprises a touch screen display and receiving a second user input indicating user selection of an alphanumeric character comprises receiving a touch input via said touch screen display.

In some exemplary methods, the first and second user inputs are received via one of an input key, a wheel, a pointing device, a touch-sensitive input, and an optical input.

### BRIEF DESCRIPTION OF THE DRAWINGS

FIG. 1 illustrates the main functional components of a mobile communication device according to one exemplary embodiment of the present invention.

FIG. 2 illustrates an exemplary mobile communication device according to a first embodiment.

FIG. 3 illustrates an exemplary text input method according to one embodiment of the present invention.

FIG. 4 illustrates an exemplary mobile communication device according to a second embodiment.

FIG. 5 illustrates an exemplary mobile communication device according to a third embodiment.

FIG. 6 illustrates an exemplary mobile communication device according to a fourth embodiment.

FIG. 7 illustrates an exemplary mobile communication device according to fifth embodiment.

### DETAILED DESCRIPTION

Referring now to the drawings, a mobile communication device 100 with dual input text entry is shown. During a text entry mode, the user selects alphanumeric characters using first and second input devices. The user selects a row in an alphanumeric array using the first input device and selects a character in the selected row using the second input device. A processor receives the first and second inputs and outputs a corresponding character to a display and/or to memory.

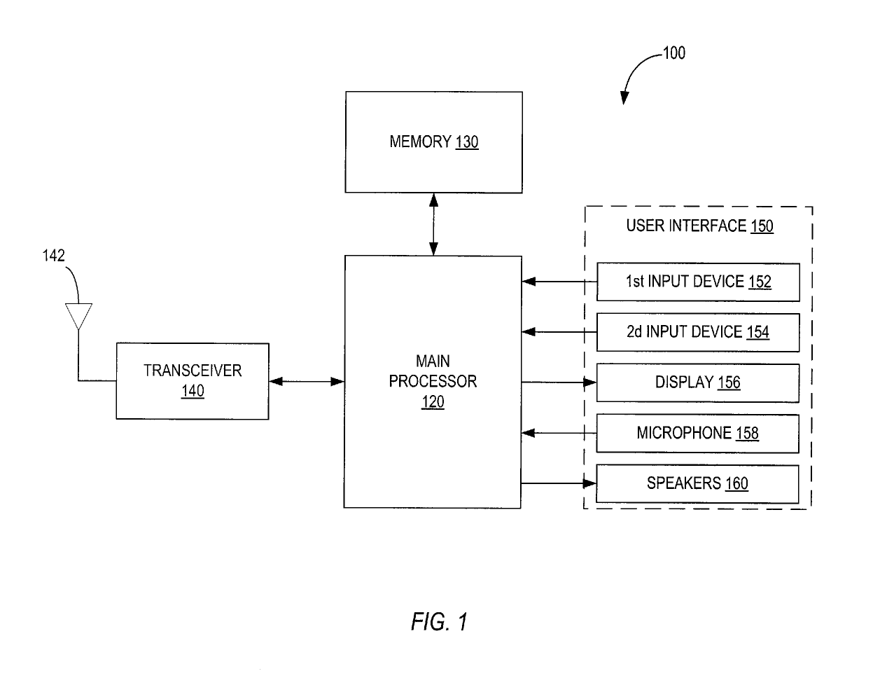

FIG. 1 illustrates the main functional components of the mobile communication device 100. The mobile communication device 100 includes a main processor 120, memory 130, wireless communication interface 140, and user interface 150. Main processor 120 controls the overall operation of the mobile communication device 100 according to program instructions stored in memory 130. Memory 130 stores program instructions and data needed for operation. Wireless communication interface 140 enables communication with remote devices, and may, for example, comprise a standard cellular transceiver, or a short-range wireless interface, such as a Bluetooth transceiver or wireless LAN interface (e.g., 802.11x). User interface 150 enables the user to interact with and control the mobile communication device 100. In the exemplary embodiment shown in FIG. 1, user interface 150 comprises first and second input devices 152 and 154 respectively, and a display 156. The first and second input devices 152, 154 may comprise any conventional input devices, such as keypads, wheels, touch pads, pointing devices, optical inputs, etc. If display 156 is a touch screen display, the display 156 may also function as the first or second user input device 152,154. User interface 150 may also include a microphone 158 for converting acoustic signals to electrical audio signals for input to the processor 120 and one or more speakers 160 for converting electrical audio signals output by the processor 120 into acoustic signals that may be heard by the user.

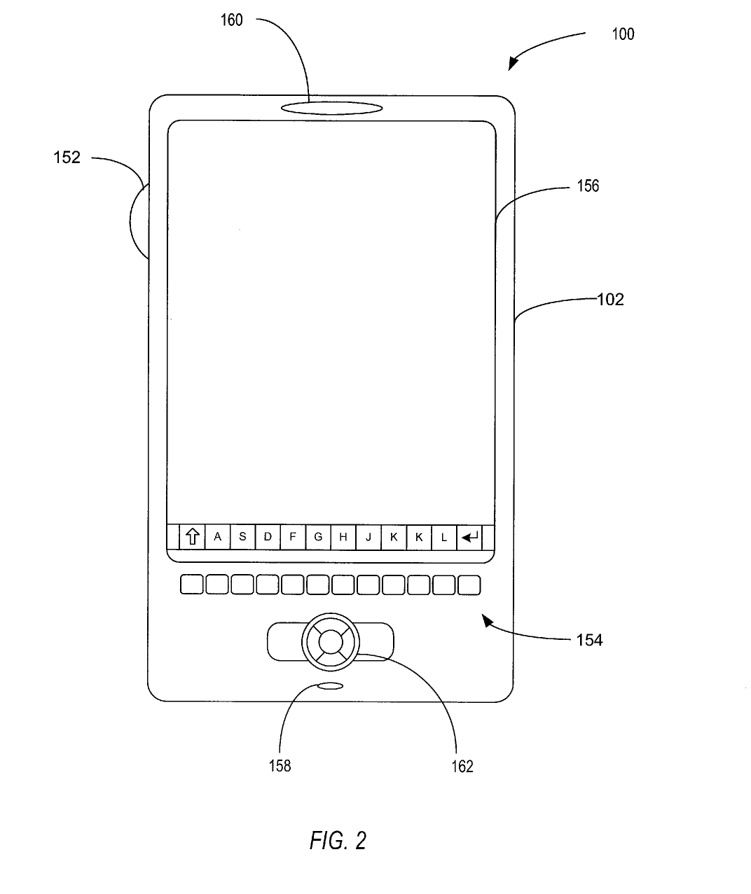

FIG. 2 illustrates one exemplary arrangement of the first and second input devices 152, 154. In this embodiment, the mobile communication device 100 includes a housing 102. Display 156 is disposed on a front face of the housing 102. The first user input device 152 comprises a wheel or dial disposed on one side of the housing 102. The second user input device 154 comprises a set of twelve keys located on the front of the housing 102 immediately below the display 156. Other input devices may also be provided for example, the embodiment shown in FIG. 2 also includes a four-way navigation control 162 as an additional input device.

As shown in FIG. 2, a single row of a standard QWERTY keyboard is displayed as virtual keys in the lower portion of display 156. The virtual keys displayed on the display 156 are aligned with corresponding keys of the second user input device 154. A conventional QWERTY keyboard comprises four or five rows of keys. Some of the keys correspond to alphanumeric characters, while other keys (e.g, the ENTER key and SHIFT key) perform other typing functions. According to the present invention, only one row of the QWERTY keyboard is displayed to the user at a time. The first user input device 152 is used to select a row of the virtual QWERTY keyboard. The twelve keys of the second user input device are used to select a key in the displayed row of the virtual QWERTY keyboard. It may be noted that some of the keys correspond to characters while other keys correspond to non-character typing functions. Using the two input devices 152, 154, the user may select and enter text by first selecting a row and then selecting a character in the selected row.

The virtual QWERTY keyboard may be implemented as a character array that is stored in memory 130 or implemented through programming logic. The character array includes a plurality of rows and columns wherein each row corresponds to one row of a QWERTY keyboard. Alphanumeric characters and other non-character typing functions are mapped to corresponding positions in the character array. Preferably, the mapping of characters to positions within the character array is made in a manner that resembles the layout of a QWERTY keypad.

When the mobile communication device 100 is in a text entry mode, the user selects a row of the character array using the first input device 152 by turning the jog dial or wheel. When the wheel is turned, a new row of the character array is displayed. For example, when the wheel is turned in a first direction, the next higher row of the character array may be displayed. Conversely, when the wheel is turned in a second direction, the next lower row may be displayed. Wrapping from the highest row to the lowest row, and vice versa, may be used.

When a row is selected by the user, the user may enter text by selecting a character using one of the twelve keys of the second user input device 154. Selection of a character is done by pressing the key adjacent to the desired character on the display 156. The visual appearance of the selected character may be changed for a brief period of time to provide visual feedback to the user indicating that a character has been selected. Such visual feedback may be provided by changing the color or size of the selected character.

When entering text, consecutive characters may sometimes appear in the same row of the character array. In this case, the user may select the row and then press two or more keys of the second user input device 154 in sequence to select the characters. That is, pressing two different keys of the second user input device consecutively without changing the row will enter two different characters in the same row of the character array.

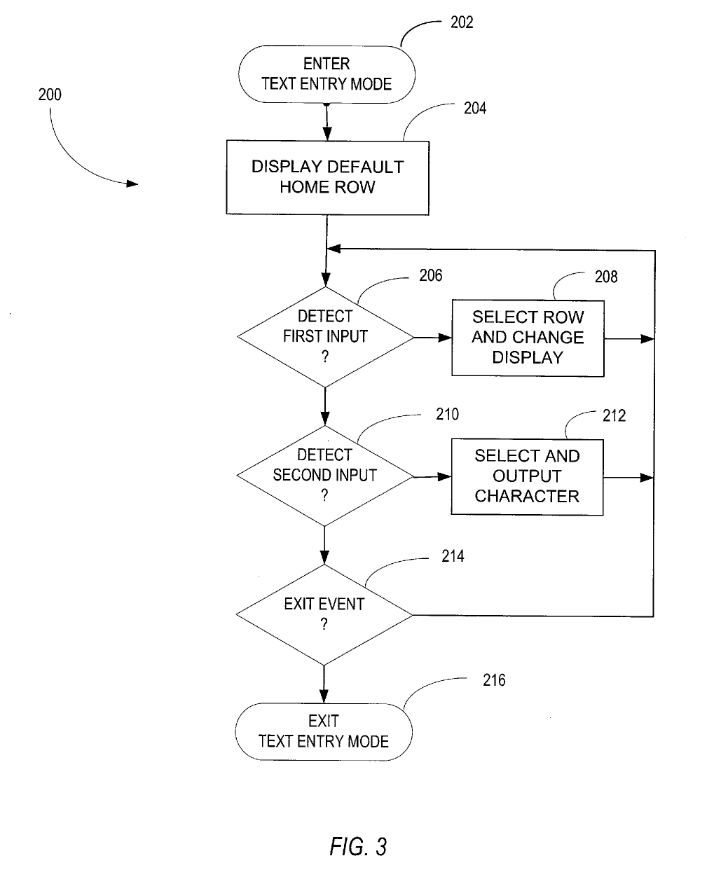

FIG. 3 illustrates an exemplary text-input method 200 for entering text. The method 200 begins when a text-input mode is invoked (block 202). The invocation of the text-entry mode is typically under the control of an application program. When the text-entry mode is entered, the mobile communication device 100 selects and displays a default home row of the character array (block 204). When a first user input is detected (block 206), processor 120 selects a row of the character array based on the first user input and displays the selected row (block 208). The first user input is received via the first user input device 152. When a second user input is detected (block 210), mobile communication device 100 selects a character in the currently selected row and outputs the selected character to the display 156 or to memory 130 (block 212). This process repeats continuously until an exit event is detected (block 214), and the text entry mode is terminated (block 216).

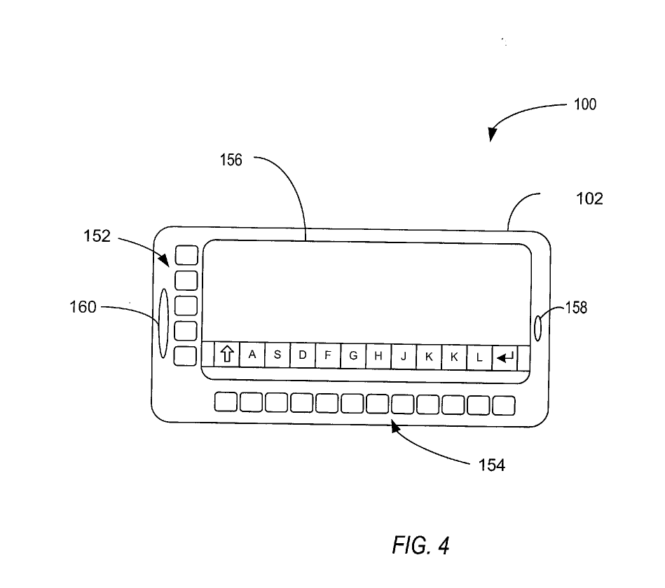

FIG. 4 illustrates an alternative arrangement of the first and second user input devices 152, 154. In this embodiment, the mobile communication device 100 includes a display 156 disposed on the front face of a housing 102. The first user input device 152 comprises a set of keys vertically arranged along one side of the display 156. The second user input device 154 comprises a second set of keys disposed along the bottom edge of the display 156. Each key of the first user input device 152 corresponds to a single row of the character array. The second user input device 154 functions in the same manner as described above. The user selects a row by pressing a corresponding key of the first user device 152, and then selects a character in the selected row by pressing the corresponding key of the second user input device 154.

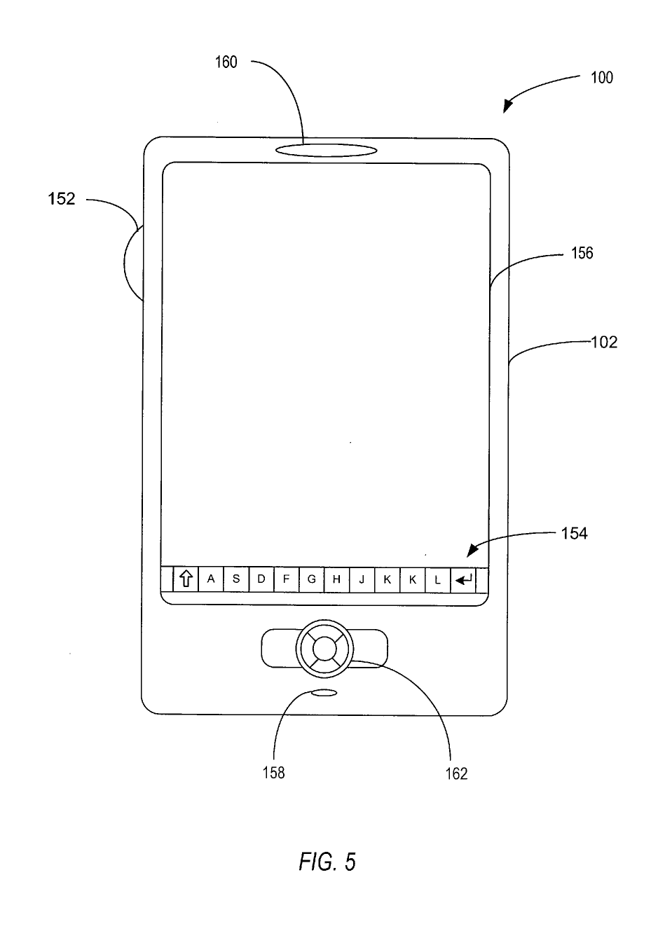

FIG. 5 shows another alternative arrangement of the first and second user input devices 152, 154. In this embodiment, a touchscreen display 156 is disposed on the front face of the housing 102 and a dial or wheel is disposed on the side of the housing 102. The jog dial or wheel functions as the first user input device 152. The touchscreen display 156 functions as the second user input device 154. When a row is selected and displayed on the display 156, the user selects a character by touching the desired character on the display 156. This embodiment is essentially the same as the embodiment shown in FIG. 2 with the input keys being replaced by virtual keys on the display 156.

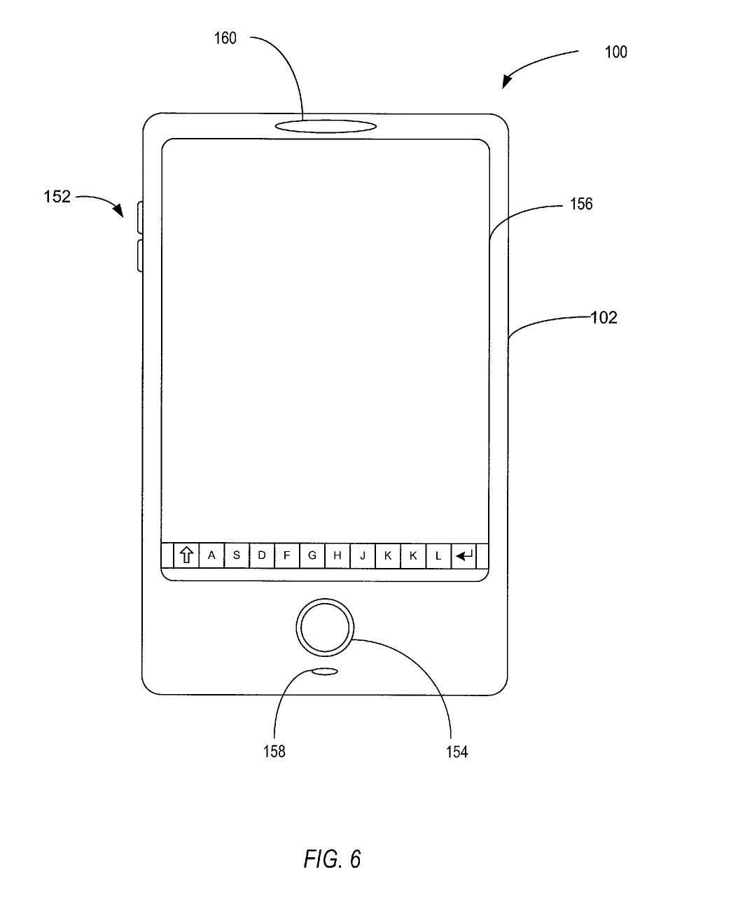

FIG. 6 shows a fourth alternative arrangement for the first and second user input devices 152, 154. In this embodiment, a display 156 is disposed on the front face of the housing 102. A pair of push buttons disposed on the side of the housing function as the first user input device 152. A rotary dial with push button functionality functions as the second user input device 154. To change the displayed row, the user presses one of the buttons of the first user input device 152. Each press of a first button moves the selection up one row, while each press of a second button moves the selected down one row. Wrapping from top to bottom row, and vice versa, may be used. When a row is selected, the user selects a desired character by rotating the dial 154 clockwise or counter-clockwise to highlight a desired character on the display 156. When a desired character is highlighted, the dial 154 is pressed to select the highlighted character.

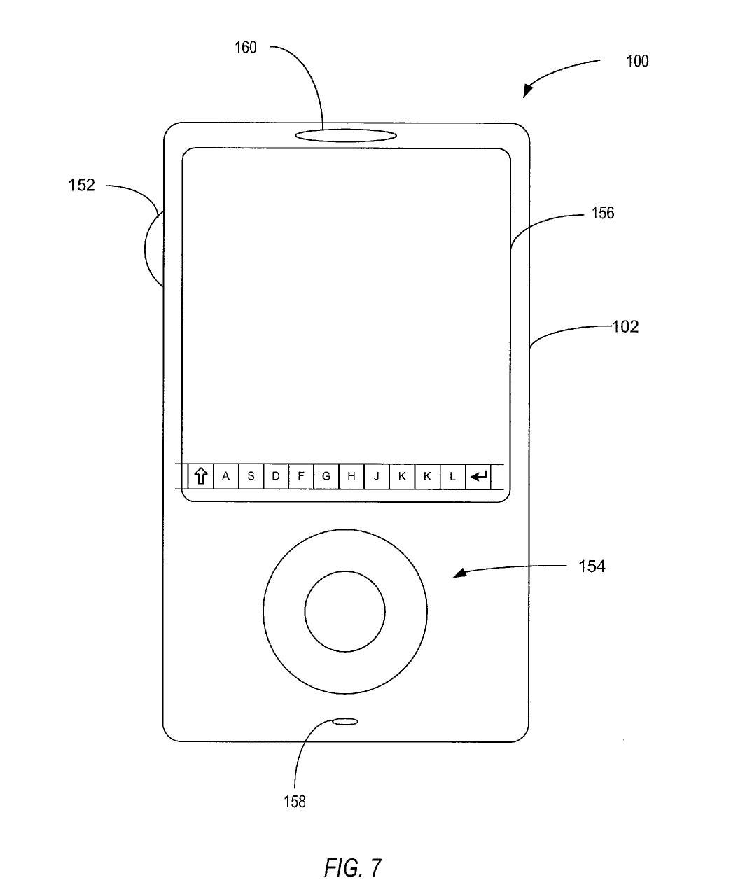

FIG. 7 illustrates another alternative arrangement of the first and second user input devices 152, 154. In this embodiment, a display 156 is disposed on the front face of the housing 102. A wheel is disposed on the side of the housing and functions as the first user input device 152. A circular touchpad is disposed on the front face of the housing and functions as the second user input device 154. The touchpad 154 includes a push button edit center. A user selects a desired row using the wheel 152 as previously described. When a desired row is selected, the user may highlight a desired character on the selected row by dragging the user finger clockwise or counter-clockwise on the touchpad 154. Dragging the user's finger in a clockwise direction moves the highlighting on the display 156 to the right, while dragging the user's finger in a counter-clockwise direction moves the highlighting on the display 156 to the left. When the desired character is highlighted, the user presses the Select button on the touchpad 154.

The illustrative embodiments described herein illustrate only a few of the possible combinations of user input devices that may be used to implement the present invention. Those skilled in the art will appreciate that many other combinations of user input devices are possible.

1. A device for entering alphanumeric characters into a computing device, said device comprising:
a housing;
a display disposed on a front face of the housing;
a first user input device, disposed adjacent a left or right edge of the display, for receiving user selection of a row in a character array containing a plurality of alphanumeric characters;
a second user input device, disposed adjacent a bottom edge of the display, for receiving user selection of an alphanumeric character in a row of said character array selected by a user via the first user in put device; and
a processor to output the selected character responsive to user input received via the second user input device.

2. The device of claim 1 wherein the processor is configured to display the selected row on said display responsive to user input received via the first user input device.

3. The device of claim 2 wherein the display comprises a touch screen display and wherein the touch screen display also functions as the second user input device for receiving user selection of a character in a selected row.

4. The device of claim 2 wherein the processor is configured to change the appearance of the selected character on said display responsive to user input received via the second input device to indicate the user selection of a character.

5. The device of claim 4 wherein the processor is configured to highlight the selected character to indicate the user selection of a character.

6. The device of claim 4 wherein the processor is configured to change the size of the selected character to indicate the user selection of a character.

7. The device of claim 1 wherein the second user input device comprises one of an input key, a pointing device, a touch-sensitive input, and an optical input.

8. A method of inputting text into a computing device having a housing and a display disposed on a front face of the housing, comprising:
receiving a first user input at a first input device, disposed adjacent a left or right edge of the display, indicating a user selection of a row in a character array containing a plurality of alphanumeric characters;
receiving a second user input at a second input device, disposed adjacent a bottom edge of the display, indicating user selection of an alphanumeric character in a row of said character array selected by a user via the first user input device; and outputting the selected character responsive to second user input.

9. The method of claim 8 further comprising displaying the selected row of said character array on said display responsive to said first user input.

10. The method of claim 9 wherein the display comprises a touch screen display and wherein receiving a second user input indicating user selection of an alphanumeric character comprises receiving a touch input via said touch screen display.

11. The method of claim 9 further comprising changing an appearance of the selected character on said display responsive to said second user input to indicate the user selection of a character.

12. The method of claim 11 wherein changing an appearance of the selected character on said display comprises highlighting the selected character.

13. The method of claim 11 wherein changing an appearance of the selected character on said display comprises changing the size of the selected character.

14. The method of claim 8 wherein the second user input is received via one of an input key, a pointing device, a touch-sensitive input, and an optical input.

15. The device of claim 1 wherein the first user input device comprises either a wheel or a pair of push buttons disposed on a side of the housing adjacent the left or right edge of the display.

16. The device of claim 15, wherein the wheel or pair of push buttons is disposed at a vertical position on said side of the housing proximal to a top edge of the display.

17. The device of claim I wherein the first user input device comprises a set of input keys arranged on the front face of the housing along the left or right edge of the display.

18. The method of claim 8 wherein the first user input is received via either a wheel or a pair of push buttons disposed on a side of the housing adjacent the left or right edge of the display.

19. The method of claim 18 wherein the wheel or pair of push buttons is disposed at a vertical position on said side of the housing proximal to a top edge of the display.

20. The method of claim 8, wherein the first user input is received via a set of input keys arranged on the front face of the housing along the left or right edge of the display.
